(19) United States
(12) Patent Application Publication
(10) Pub. No.: US 2009/0018942 A1
(43) Pub. Date: Jan. 15, 2009

(54) SYSTEM AND METHOD FOR ONLINE AUCTION

(75) Inventors: Robert Hamman, Dallas, TX (US); Elliott Brackett, Dallas, TX (US)

Correspondence Address: HOWISON & ARNOTT, L.L.P, P.O. BOX 741715, DALLAS, TX, 75374-1715, US

(73) Assignee: SCA PROMOTIONS, INC., DALLAS, TX (US)

(21) Appl. No.: 11/775,144

(22) Filed: Jul. 9, 2007

(51) Int. Cl. G06Q 40/00

(52) U.S. Cl. 705/37

(57) ABSTRACT

A computer-implemented method of conducting an online auction includes the steps of receiving listing information from a seller for creating a listing for a product offered for sale by the seller, enabling the seller to select a chance-based incentive to encourage bidders to bid on the product, storing the listing information in a computer searchable database, the listing information identifying those listings having associated chance-based incentives, receiving one or more search requests including search criteria from one or more bidders, searching a database for products matching the search criteria, transmitting information for those products matching the search criteria such that a list of those products matching the criteria can be displayed to one or more bidders and identifying those products having a chance-based incentive, receiving one or more bids for the product from one or more bidders and identifying a successful bid for the product and the successful bidder placing the successful bid and determining whether the successful bidder is the winner of the chance-based incentive.

### TECHNICAL FIELD

This invention is related to online auctions and to incentives associated with listed products to promote bidding on such products.

### BACKGROUND

Online auctions have become a favorite way for millions of consumers to buy and sell products. The popularity of online auctions is due to the ease and convenience with which an individual having access to the Internet can list a product for sale or locate a product that he or she wishes to buy. One of the key factors in the success of an online auction site is the number of listings for the same or similar product. Multiple listings for the same or similar products provide buyers with choices. Buyers can compare prices, product features, shipping costs and other factors before bidding on a product.

Sellers, on the other hand, are presented with the problem of making their listings stand out from other listings for the same or similar products. Online auction sites or houses such as EBay offer sellers several ways to differentiate their listings. A seller may opt, typically for an additional fee, to include gallery pictures, subtitles and selected “featured” placement of his or her listing. The seller can elect to have the listing displayed in a bold font, include borders and highlighting. These listing options are designed to increase the visibility of listing while simultaneously providing the auction house with incremental revenue.

### SUMMARY

In a method according to the invention, a seller using an online auction to sell a product is given the option of listing his or her product with a chance-based incentive. For example, in one variation, the seller may select one of three incentives. The seller may select a first incentive that gives the purchaser of the product a one in one hundred (1:100) chance of receiving the product for free. In exchange, the seller agrees to pay the auction house a fee, for example 1.25% of the final sales price, for listing the product with an icon or symbol identifying the incentive to prospective bidders. The second chance-based incentive gives a purchaser of the product a one in fifty (1:50) chance of receiving the product for free. In exchange, the auction house collects a fee of 2.5% of the final purchase price of the product from the seller. A third chance-based incentive enters the purchaser into a lottery or sweepstakes for an amount equal to one thousand times the purchase price of the product. In this case, the auction house may collect a fee of 3% of the purchase price from the seller. The foregoing chance-based incentives are exemplary only; numerous variations on the awards, fees and details are possible. In each case the aggregate fees for listing products with a chance-based incentive will be sufficient to cover the cost of the incentive plus a percentage for the auction house or the entity conducting the incentive program.

In one aspect, in order to list the product with the chance-based incentive feature, the seller agrees to pay an incremental amount of the final sales prices. The listing is then displayed with an icon or other indicia that indicates to a bidder that he or she may be awarded a prize in the event that the bidder places the winning bid. In one variation, the winning bidder may receive the product for free. In another variation, the bidder may be entered into a sweepstakes. In the event that the bidder wins the sweepstakes, the bidder may be awarded a fixed amount, an amount equal to some multiple of the final sales price (with or without a ceiling or maximum value) or some other prize.

A computer-implemented method of conducting an online auction in accordance with the disclosure includes receiving listing information from a seller for creating a listing for a product offered for sale by the seller and enabling the seller to select a chance-based incentive to encourage bidders to bid on the product. The listing information is stored in a computer searchable database and identifies those listings having associated chance-based incentives. One or more search requests including search criteria are received from one or more bidders and a search of the database is conducted to identify products matching the search criteria. Information regarding products matching the search criteria is transmitted such that a list of those products matching the criteria can be displayed to one or more bidders with those products having a chance-based incentive identified with an indicia. Bids for the product are received from one or more bidders and a successful bid for the product and the successful bidder placing the successful bid are identified. If the item or product was listed with a chance-based incentive, the next step is determining whether the successful bidder is the winner of the incentive. In one variation, if the successful bidder is a winner, the method may include transferring or arranging the transfer of the chance-based incentive to the successful bidder.

In one aspect, a plurality of sellers each pay a fee for listing products with a chance based incentive. The fee may be a percentage of the final sale price of the sale item, in which case, the fee is calculated and collected upon completion of the auction.

A computer implemented method of conducting an online auction as disclosed herein includes receiving criteria enabling a search of a database of information regarding items for sale and searching the database using one or more of the criteria and identifying items matching the criteria and further identifying items matching the criteria having an associated chance-based incentive. An electronic message enabling a display of information for those items matching the criteria, including for those items having an associated chance-based incentive an indicia indicating that a chance-based incentive is associated with the item, is transmitted to enable bidders to view items matching search criteria. Bids for the item are received and a successful bidder is identified. A random selection process is then applied to determine whether the successful bidder is a winner of the chance-based incentive.

In one aspect, listing information is received from a plurality of sellers and the information is stored and used to create a plurality of listings for products offered for sale by the sellers. At the time the listing information is submitted by the sellers, the sellers are allowed to choose a chance-based incentive for a fee to encourage bidders to bid on the items. An indicia is then displayed with listings of those sellers that choose the chance-based incentive to indicate to potential bidders that a successful bidder may be a winner of the chance-based incentive. In one variation fees for listing items with the chance-based incentive are determined as a percentage of the final sales price of the items and collected at the conclusion of the auctions for the items. In other variations the fee may be determined at the time of listing and collected with the listing fee, if any.

In another aspect, a system for enhancing an online transaction uses an electronic transaction engine having a data communications interface allowing a seller to communicate information relating to a product for sale to the transaction engine via a network. The transaction engine also transmits information regarding the product to potential purchasers via the network. The system includes an electronic contest engine having a communications interface enabling the contest engine to communicate with the transaction engine and with the seller of a product. The contest engine communicates with the seller and with the transaction engine to associate a chance-based incentive with a product offered for sale by the seller using the transaction engine.

The chance-based incentive is associated with the product by means of indicia presented in a display of information regarding the product transmitted by the transaction engine to potential purchasers via the network. In one aspect, the contest engine includes a computer operating a random selection program wherein the random selection process determines whether a purchaser wins the chance-based incentive. In another, the contest engine maintains a webpage accessible by purchasers of products listed using the transaction engine with a chance-based incentive, whereby a purchaser may enter an authorization code to activate a random selection process to determine if the purchaser is a winner of a chance-based incentive.

In one variation, the transaction engine operates an online auction site through the data communications interface wherein sellers transmit information regarding products for sale and the transaction engine transmits a listing of products for display on a user communication device, typically in response to a query electronically transmitted to the transaction engine by a potential purchaser. The listing may include indicia indicating that one or more products offered by sale includes a chance-based incentive.

In one aspect, the contest engine receives information from the transaction engine through the data communications interface identifying a listing of a product for sale by a seller and transmits a message to the seller through the data communications interface, the message offering to provide a chance-based incentive with the seller's listing. In one variation, the transaction engine removes the seller's contact information from the information transmitted to the contest engine. In this variation, the message from the contest engine to the seller is transmitted to the transaction engine via the communications interface and then to the seller.

If a product is to be listed with a chance-based incentive, the contest engine transmits an authorization to the transaction engine through the data communications interface authorizing the transaction engine to display indicia with the seller's listing, the indicia indicating that the product is offered for sale with the chance-based incentive. The transaction engine receives search criteria from a potential purchaser via the data communications interface, identifies products listed for sale by sellers and transmits a listing of products meeting the search criteria to the potential purchasers for display on a personal communication device, the listing including indicia identifying products offered with a chance-based incentive.

In another variation, a system for enhancing an online auction includes a transaction engine having a data communications interface for operating an online auction via a public or private network. The transaction engine communicates with sellers and potential purchasers, receiving information from sellers relating to products offered for sale via the network, transmitting listings of products to potential purchasers for display on personal communications devices and receiving bids for the products from potential purchasers.

In this variation, the system includes a contest engine having a communications interface that enables the engine to communicate with the transaction engine and with sellers of the products to associate a chance-based incentive with a product offered for sale by a seller using the transaction engine. The chance-based incentive is associated with the product by means of indicia displayed in a listing of products transmitted by the transaction engine to potential purchasers via the network. The seller may pay a fixed fee or a percentage of the sale price of a product for listing the product for sale with a chance-based incentive.

In yet another variation, the contest engine, transaction engine, sellers and purchasers communicate with a payment engine including a data communications interface with the network, the payment engine transferring funds from accounts maintained by sellers for payment of fees for chance-based incentives when authorized by the sellers. The payment engine may transmit fees for chance-based incentives from accounts maintained by sellers to an account maintained in connection with the contest engine or to an account maintained in connection with the transaction engine for receiving such fees. In one aspect, the contest engine includes a computer operating a random selection program wherein the random selection process determines whether a purchaser wins the chance-based incentive and wherein the contest engine communicates with a payment engine via the network and authorizes the payment engine to transfer the value of the chance-based incentive to a winning purchaser.

As disclosed herein, a computer-implemented method of enhancing an online auction includes the steps of: (1) providing a seller of a product to be sold via the online auction with a chance-based incentive to be awarded to a purchaser of the product, (2) authorizing the product to be listed for sale in the online auction with indicia indicating that the product is offered with a chance based incentive, (3) applying a random selection process to determine if a purchaser of the product is a winner of the chance-based incentive, and (4) receiving a fee from the seller for providing the chance-based incentive. The fee for the chance-based incentive may be fixed, in which case, it may be collected from the seller at the time the seller selects the incentive. Alternatively, the fee may be a percentage of the purchase price of the product. In this case, the fee is calculated and collected at the conclusion of the auction. The fee may be received from an electronic payment engine authorized by seller to make such a payment.

In one variation, the step of providing a seller of a product to be sold via the online auction with a chance-based incentive to be awarded to a purchaser of the product includes identifying sellers of products listed for sale with the online auctions, transmitting a offer to such sellers to provide the chance-based incentive and receiving acceptances of the offer from sellers. In one aspect, the entity conducting offering the chance-based incentive provides a webpage where sellers may choose a chance-based incentive as a sales aid.

The entity providing the chance-based incentive may require confirmation that a purchaser of a product listed for sale in the online auction prior to applying the random selection process. In another, the entity may provide a predetermined period of time in which the seller may provide notification that a purchaser has not paid for a product listed for sale in the online auction with a chance-based incentive prior to applying the random selection process.

### BRIEF DESCRIPTION OF THE DRAWINGS

For a more complete understanding, reference is now made to the following description taken in conjunction with the accompanying Drawings in which:

FIG. 1 illustrates a system for conducting an online auction;

FIG. 2 illustrates an exemplary screen display for entering information regarding items to be listed on an online auction;

FIG. 3 illustrates an exemplary screen display for selecting listing features and incentives for items to be listed on an online auction;

FIG. 4 is a flow chart illustrating a method of conducting an online auction as disclosed herein;

FIG. 5 is a second flow chart further illustrating a method of conducting an online auction as disclosed herein;

FIG. 6 illustrates a display of listings of items for sale according to the method disclosed herein;

FIG. 7 is a schematic representation of a system for conducting an online auction using a chance-based incentive;

FIG. 8 is a schematic representation of the system of FIG. 7 wherein components and users of the system communicate electronically via a network;

FIG. 9 is schematic representation of a transaction engine of the system of FIG. 8;

FIG. 10 is a schematic representation of a contest engine of the system of FIG. 8;

FIG. 11 is a schematic representation of a payment engine for use with the system of FIG. 8;

FIG. 12 is flow chart illustrating a method of conducting an online auction using with the system of FIG. 8;

FIG. 13 is a block diagram illustrating the interaction of users and the components of the system of FIG. 8 in one variation; and

FIG. 14 is a block diagram illustrating the interaction of users and the components of the system of FIG. 8 in a second variation.

### DETAILED DESCRIPTION

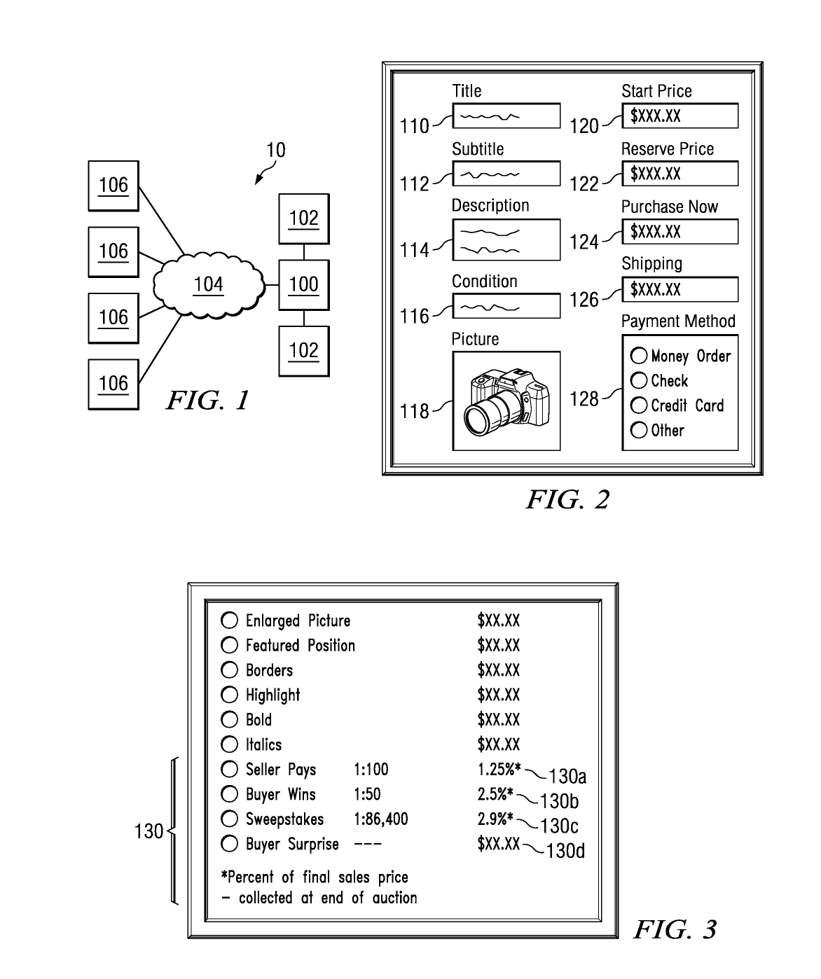

FIG. 1 illustrates a system and environment 10 in which an online auction is typically conducted. One or more auction servers 100 having one or more associated databases 102 are linked to a public network 104 such as the Internet for communicating with users of the online auction site. As used herein, the term “server” refers to a computer that delivers information and/or software to other computers via a network. Users, e.g., sellers and buyers, use communication devices 106 such as personal computers, cell phones or similar devices to communicate with auction servers 100 to place listings and bid on items via network 104. Servers 100 communicate with devices 106 using a protocol such as Hyper Text Transfer Protocol (http) which enables transmission of information in the form of text documents coded in a standard markup language such as Hyper Text Markup Language (HTML). Databases 102 are used to store listing databases, e.g., information regarding items for sale, the identity of buyers and sellers, bids and related information and other information necessary to conduct online auctions.

Servers 100 communicate with prospective sellers by transmitting information enabling communications devices 106 to display preformatted screens that enable sellers to enter information regarding items that such sellers wish to list for sale on an online auction site. This information may include the title of the listing, a detailed description of the item or items, a reserve and/or starting price for the item, a picture of the item and other relevant information. Servers 100 save such information in listing database(s) and may use the information to create preformatted listing displays that can be electronically transmitted to potential bidders and displayed on communication devices 106. Servers 100 also communicate with prospective buyers or bidders by transmitting information enabling communications devices 106 to display preformatted screens that enable the prospective buyers to enter search criteria for items that they may wish to purchase. Such information may include a brief description of the item, a price range that they are willing to consider, particular features that they wish such items to include and other relevant information. Servers 100 use this information to search the listing databases to identity items that match the criteria and transmit information to devices 106, enabling the devices to display lists of items matching the criteria to prospective buyers.

Servers 100 also receive bids electronically transmitted by buyers or prospective buyers and determine a successful bid, if any, for the item. Typically, the successful bid is the highest price bid for an item before the end of the auction. The end of the auction is typically determined as a time interval beginning at the time an item is listed. For example, an auction for an item may continue for five days from the time the item is listed.

In a typical auction, the online auction house may charge a seller a listing fee and/or a percentage of the sale price of the item. The auction may provide the seller the option of enhancing the appearance of his or her listing as a means of differentiating the listing from other listings for the same or similar items. Typically the auction house charges the seller a set fee for enhancing the listing, depending upon the particular enhancement(s) selected by the seller.

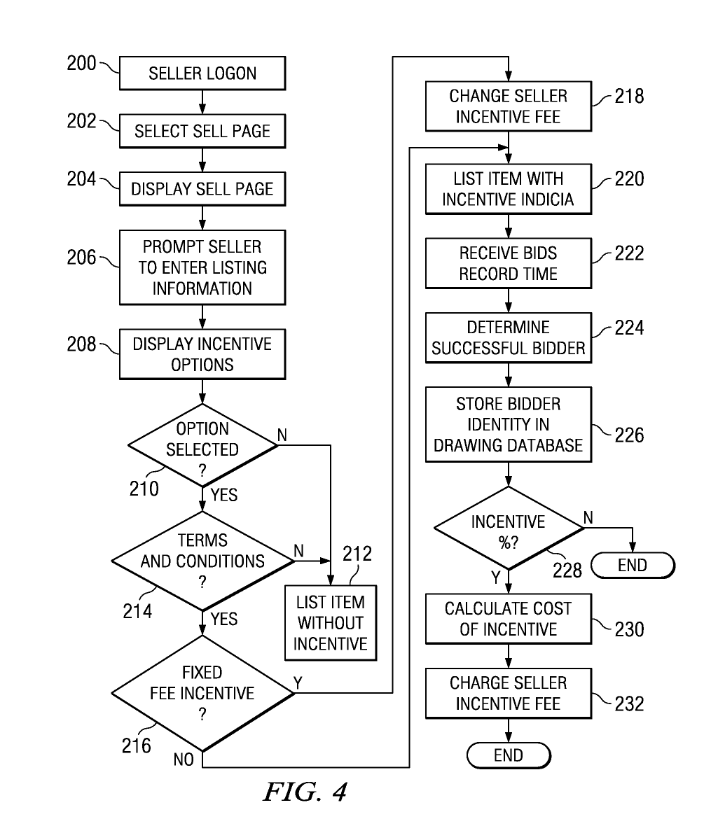

Referring to FIG. 4, a prospective seller wishing to sell an item access the auction house home page using a communication device 106 (FIG. 1) such a personal computer and logs onto the auction house web site, typically using an assigned personal identification number and password (Step 200). The prospective seller may click on a “sell” link (Step 202) displayed in the auction house's home page that opens a sell screen or page (Step 204). The seller is prompted to enter information regarding the item to create a listing for the item. (Step 206). Typically one or more screens are displayed, prompting the seller to enter additional information at each screen and create a listing for the item. FIG. 2 is exemplary input screen illustrating data fields that a seller may be prompted to complete during the listing process.

Referring to FIG. 2, in one variation, the seller may be prompted to enter a title 110, subtitle 112, detailed description 114 and condition 116 of the item. The seller may be prompted to provide a picture 118 of the item for the listing. The seller may be prompted to enter a starting price 120, a reserve price 122 and/or a “purchase now” price 124. The seller may also be prompted to enter accepted methods of payment 128 and fees for shipping and handling 126. The information provided by the seller is collected, stored in one or more of databases 102 (FIG. 1) and processed to create a listing for the item that may be displayed in response to search requests.

Referring now to FIGS. 3 and 4, during the process of creating the listing, the seller may be prompted to add one or more features to the listing to distinguish the listing from listing for the same or similar items. For an additional fee, the seller may add enhanced or enlarged pictures, subtitles, borders, highlighting and bold or italic font to the listing. In some cases the seller may select a “featured” placement for his or her listing that places the listing ahead of other listing for the same or similar items in a list displayed in response to a search request.

Referring still to FIGS. 3 and 4, in one variation, the seller is provided with the option of listing his or her product or item with one or more chance-based incentives 130 (Step 208) in exchange for a relatively small percentage of the final sales price of the item or a fixed fee. As used herein the term “chance-based incentive” refers to a prize or an award given to a bidder as the result of a random selection process wherein a winning successful bidder is selected based upon predetermined odds. For example, the seller may select a “Seller Pays” incentive that provides the buyer a 1:100 chance of winning an amount equal to the purchase price of the item. In one variation, non-bidders may be provided an alternate method of entering a contest for a comparable chance-based incentive.

In one embodiment, the seller may choose to add a chance-based incentive the listing of his or her product at any time during the auction. For example, if the seller lists a product or item with the auction house and decides a day later to add a chance-based incentive to the listing, the seller may log on, access the listing and display the incentive options (Step 208). The seller may then select a chance-based incentive to be added to his or her listing.

The random selection process may utilize a random number generator, a lottery-type algorithm or a similar method of randomly choosing one member of a group. For example, since all bids received by an online auction house are automatically time stamped, the time at which a bid was received or a value associated with the time may be compared with the output of a random number generator to determine a winner. Other known methods of randomly selecting one or more member(s) of a group may also be used to select winners.

Referring still to FIGS. 3 and 4, in the illustrated embodiment, the seller may select a chance-based incentive (Step 210), such as “seller pays” incentive 130a which gives a winning bidder a 1:100 chance of receiving an amount equal to the purchase price of the item. In exchange, the seller agrees to pay the auction house or other entity conducting the incentive program 1.25% of the final sales price. The seller may choose to list his item with a “buyer wins” incentive 130b in which the winning bidder has a 1:50 chance of receiving an amount equal to the purchase price of the item. In this variation, the seller agrees to pay, for example, 2.5% of the sales price for the incentive. Another chance-based incentive option may be a “Sweepstakes” incentive 130c in which the winning bidder is entered into a lottery with, for example, a 1:86,400 chance of winning 1000 times the purchase price of the item. In this case the seller agrees to pay the auction house or entity conducting the incentive program 2.9% of the sales price. Other chance based incentives could include trips, event tickets, items related to the sale item or other value. To cover the cost of the chance-based incentive, the seller will be charged a relatively small percentage of the sale price of the item to the auction house as a fee for listing an item with the chance-based incentive.

In another variation, the seller may elect a fixed fee “buyer surprise” chance based incentive 130d. In this variation, the seller pays a fixed fee, for example, from $0.50 to $2.00, at the time of the listing to apply the incentive to his or her listing. In this variation, the winning bidder will be eligible to enter a sweepstakes for a predetermined prize. In this variation, the seller pays the auction house or entity conducting the sweepstakes the fixed fee at the time the seller chooses the fixed fee chance-based incentive.

In one variation, the seller may be charged an insertion fee or registration fee at the time the seller chooses a chance-based incentive. The insertion or registration fee may be a nominal amount, for example $0.25 or $0.50. If the seller chooses a chance-based incentive having a fee based on a percentage of the sale price of the product or item, the insertion may or may not be applied against the percentage fee. In this variation, the auction house or entity conducting the chance-based incentive promotion collects the insertion fee regardless of the outcome of the auction.

In one variation, the seller will be prompted to accept the terms and conditions for the chance-based incentive (Step 214). If the seller elects one or more of the chance-based incentives and accepts the terms and conditions, the listing information will be stored and/or a listing formatted for display in response to buyer initiated searches including an indicia indicating that a chance-based incentive is associated with the auction of the item. If the seller chooses a fixed fee chance-based incentive (Step 216), the seller is charged the fixed fee (Step 218). In one variation, the auction house debits a credit card, checking account or similar account maintained by the seller in the amount of the fee.

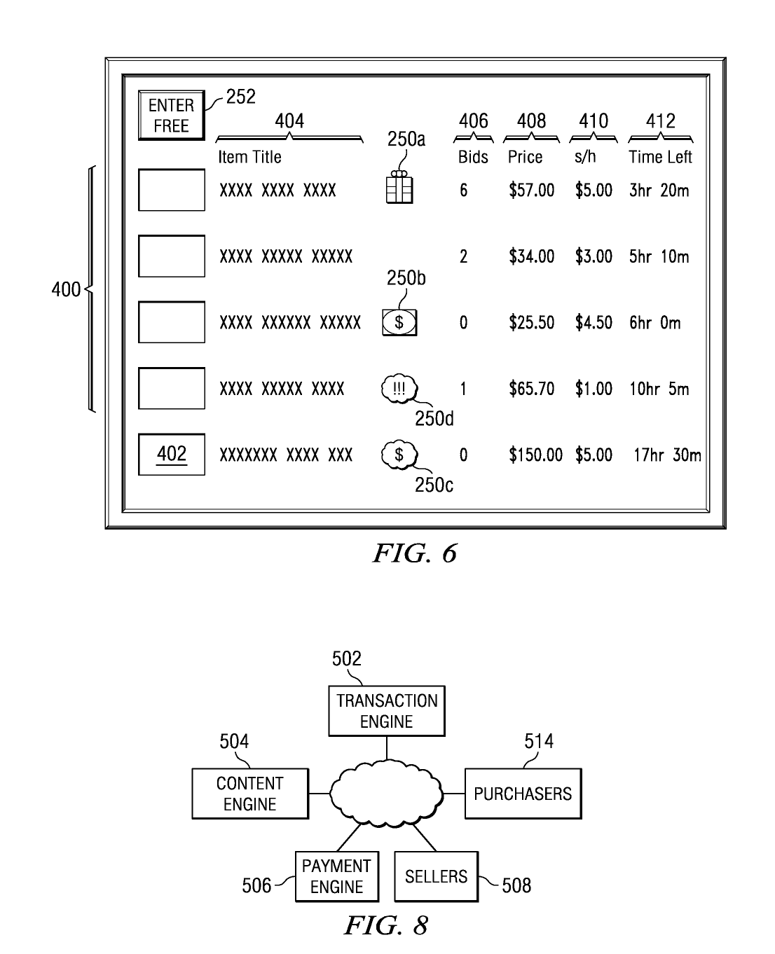

When the sale item is listed in response to a search, an icon or indicia 250 (FIG. 6) will be displayed as part of the listing to alert prospective buyers that they have a chance of winning the incentive if he or she is a successful bidder (Step 220). Different icons or indicia 250a, 250b, 250c and 250d may be used to designate different chance-based incentives. If the seller declines the terms and conditions or if the seller declines to select the chance-based incentive, the listing information is stored and/or a listing is created or formatted without the icon or indicia 250 for display in response to buyer inquires (Step 212).

Other indicia may be used in place of, or in conjunction with, icons 250a, 250b, 250c and 250d. For example, listings with an associated chance-based incentive may be displayed in a unique color, a unique font or in bold. Such listing may be underlined, in italics, may be highlighted with bright, dark or colored borders or include other features that that may be used to alert potential bidders that the listing includes a chance-based incentive. In one embodiment the chance-based incentive may be identified in text in the listing with phrases such as “SELLER PAYS!!!”, “BUYER WINS!!”, “SWEEPSTAKES!!”, “BUYER SURPRISE!! ” or similar text.

Referring again to FIG. 4, the auction house receives bids for the sale item (Step 222) and records the time the bids are received. At the end of the auction, typically after a fixed time interval beginning when the listing was placed, a successful bidder is identified (Step 224). The identity of the successful bidder along with the time that the successful bid was placed is stored in a drawing database (Step 226). If the chance based incentive is a percentage of the sale price, (Step 228), the seller's cost of the incentive is calculated (Step 230) and charged to the seller (Step 232). For example, if the seller selected the “seller pays” incentive and the sale price of the item is $100.00, the seller would be charged 1.25% of $100.00 or $1.25. Typically, the charge is debited to a credit card, debit card or another account of the seller which the seller has authorized the auction house to charge.

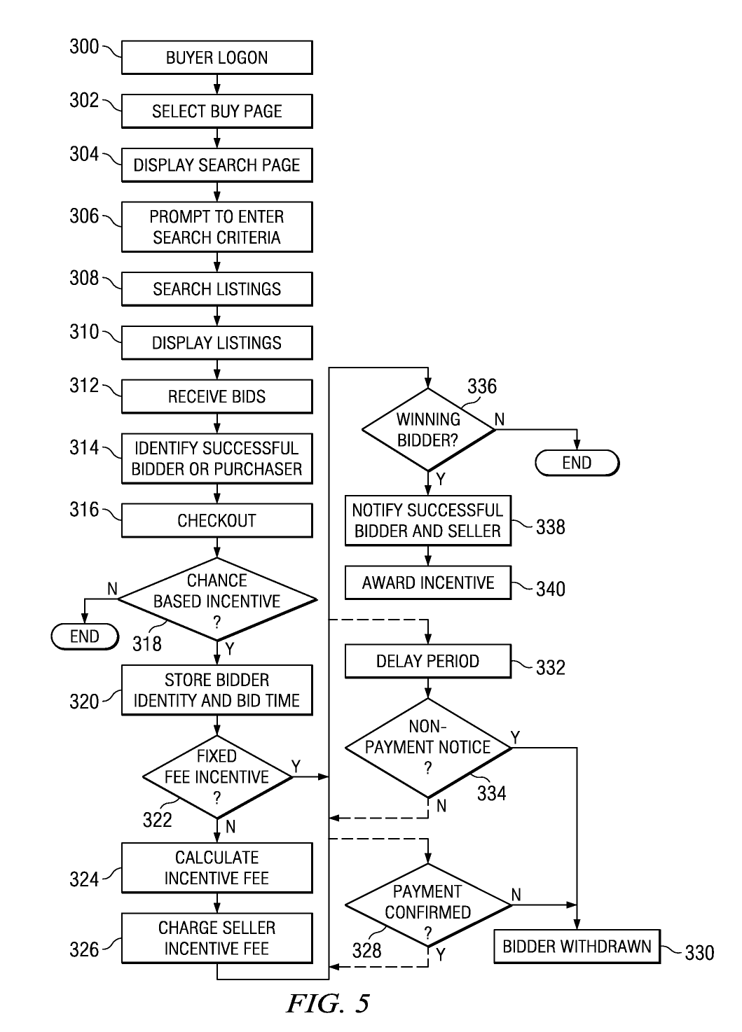

Turning now to FIG. 5, a prospective buyer searching for an item will log on to the auction house web site using an assigned personal identification number and password (Step 300). The prospective buyer clicks on a “buy” link displayed in the auction house's home page (Step 302) that opens a search page (step 304) prompting the buyer to enter information regarding the item he or she wishes to purchase (Step 306). After the prospective buyer has entered the information, he or she transmits the information to auction server 100 which searches the listing database for items matching the search criteria (Step 308) and assembles a list of such items for display to the prospective purchaser (Step 310). In one embodiment, prospective purchasers are given the option of searching for only those items listed with a chance-based incentive.

Referring now to FIG. 6, those listings that match a buyer's search criteria are typically displayed in an abbreviated form. In one variation, each of the abbreviated listings 400 may include a picture 402 of the item, the title 404 of the item, the number 406 of bids received for the item, the current price 408 or high bid for the item, shipping and handling charges 410 and the time 412 remaining in the auction. In the illustrated embodiment, an icon or indicia 250a, 250b, 250c or 250d is displayed with the listings of those items offered with a chance-based incentive. For example indicia 250a may indicate that an item is offered with a “seller pays” incentive, indicia 250b may indicate an item offered with a “buyer wins” incentive, indicia 250c may indicate a item offered with a ‘sweepstakes” incentive and indicia 250d may indicate that the item is offered with a “buyer surprise” incentive. The chance-based incentives identified with indicia 250a, 250b, 250c and 250d differentiate the items offered with the incentives from other items displayed in the list and serve to motivate prospective buyers to bid on those items versus the same or similar items offered without a chance-based incentive.

To obtain more information regarding a specific item, the prospective buyer clicks on a link displayed next to the item. The link may be the title or picture of the item. A more detailed page (not shown) is then displayed, which may include a full description of the item and additional photographs of the item as well as the information shown in FIG. 6. The more detailed page may also feature a chance-based incentive indicia such as indicia 250a, 250b, 250c or 250d and may include further details regarding the incentive.

Referring again to FIG. 5, bids for sale items are received (Step 312) until the end of the auction. A successful bidder, if any, is determined (Step 314). The term “successful bidder” means a bidder that places a bid accepted by or acceptable to the seller or, in the case of an item offered for a fixed price, the purchaser of the item or product. The successful bidder or purchaser of the auctioned item then “checks out” (Step 316), e.g., arranges for payment of the sale price to the seller who then arranges for transfer of the sale item to the successful bidder.

Server 100 (FIG. 1) determines whether the purchased product was listed with a chance-based incentive (Step 318). If the auctioned item was listed with a chance-based incentive, the bidder's identity and the time of the bid are stored in a drawing database (Step 320). Server 100 then determines if the auctioned item was listed with a fixed fee chance-based incentive, in which case the incentive fee was paid by the seller at the time he or she selected the incentive (Step 322). If the auctioned item was listed with a chance-based incentive having a fee equal to a percentage of the purchase price, the fee is calculated, (Step 324) and the seller is charged the fee (Step 326), typically by debiting an account maintained by the seller such as a credit card or similar account.

Referring still to FIG. 5, in one variation, before the successful bidder is eligible for the chance based incentive, the bidder must close the transaction, i.e., pay the seller. In this variation, confirmation of payment (step 328) is required before the successful bidder is eligible to participate in the chance-based incentive promotion. The seller may transmit a message to the auction house or entity conducting the promotion confirming that the successful bidder has paid for the item. If the seller does not confirm payment for the item, the successful bidder is withdrawn from consideration for the chance-based incentive (Step 330).

In another variation, entry of the successful bidder into the chance-based promotion is delayed (Step 332) for a predetermined period, for example one or two weeks during which the seller may notify (Step 334) the auction house that the successful bidder has not paid for the listed item. If the seller notifies the auction house that the successful bidder has not paid, the bidder is withdrawn from consideration (Step 330) for the chance-based incentive. If no notice is received from the seller, the successful bidder is considered eligible to participate.

In one variation, a random selection process or contest is utilized to determine if the successful bidder is a winner of the chance-based incentive (Step 336). For example, a random number generator may be used in conjunction with the time or a time interval that the successful bid was placed to determine if the successful bidder is a winner of the chance-based incentive associated with the sale item. The time the winning bid was placed may be compared to times or time intervals generated using the random number generator to determine whether the successful bidder is a winner of the incentive. Other lottery type algorithms and similar techniques may also be used to determine a winner. In other variations, the random selection process may be adjusted according to predetermined odds selected at the time the seller selected the incentive.

In yet other variations, a manual selection process may be performed such as spinning a numbered wheel, drawing a slip with a bidders name or other identification from a group of such slips or other such manual selection process. Such a manual selection process may be appropriate when the award of the incentive is part of a public event, televised or webcast for promotional purposes. In one variation, the random selection process is conducted by the auction house. In another, the selection process may be conducted by a third party responsible for conducting the chance-based incentive promotion.

If the successful bidder wins the chance-based incentive, server 100 generates and transmits a message to the bidder that he or she has won the incentive (Step 338) and may also notify the seller. The auction house or other entity conducting the chance-based incentive program then arranges for awarding or transferring the value of the incentive to the bidder (Step 340).

In some jurisdictions, participation in sweepstakes and other chance-based promotions (collectively referred to as “promotions”) may be restricted to consumers who provide consideration. In those jurisdictions, the right to participate may or may not be extended to consumers who do not provide consideration.

However, in many jurisdictions throughout the world sponsors of sweepstakes and other chance promotions (collectively referred to as “contests” or “promotions”) are prohibited from restricting participation in the promotion to consumers who provide consideration in return for the opportunity to participate. Consumers who wish to participate without providing consideration are given an alternate method of entry (“AMOE”) which enables them to participate on the same basis as is given consumers who provide consideration. Consumers who provide consideration are allowed to participate in promotions as are consumers who participate using one or more AMOE's. Consumers who provide consideration may also participate by using one or more AMOE's.

In those jurisdictions where an AMOE is required, there are regulations which stipulate the conditions that may be imposed on consumers who desire to participate via an AMOE. A typical requirement is that the consumer transmit request for an entry or in some cases a game piece which is used to participate in the promotion. In some cases winning consumers are required to claim their prize, in others they are notified of the fact.

Referring again to FIG. 6, in accordance with one variation of the method, users of the online auction are provided an AMOE. To participate in the chance-based incentive without bidding on a displayed item, viewers of the listings shown in FIG. 6 may click on an “enter free” icon 252 displayed on the listing screen. Icon 252 provides a link to a web page where the user may obtain an address and/or a form for requesting an authorization code to enter a chance-based incentive contest. Icon 252 may also be displayed on the auction house's home page or on other selected screens.

Once the user has the authorization code, the user may participate in the chance-based incentive program by transmitting the authorization code and/or form to the auction house and/or a third party entity conducting the chance-based incentive program. The auction house or entity may then periodically select a winner from those individuals who have elected to participate without bidding on listed items. For example, the auction house or entity may calculate an average value for items purchased by winners of the chance-based for a period of three or six months and the average odds of winning the incentive. Then, at the end of the period, the auction house or entity may apply a random selection process as described above to select a winner from those individuals who entered the chance-based incentive program without bidding on listed items.

In another embodiment, listings from sellers who choose to use a chance-based incentive as a sales aid are divided into groups based upon the anticipated final sales price of the listed items. For example, items having an anticipated sales price of one dollar to fifty dollars would be placed in a first group, items having a sales price of fifty to one hundred dollars would be placed in a second group, items having a sales price of one hundred to two hundred dollars would be placed in a third group with more valuable items being grouped accordingly. Grouping sale items in this fashion may enable the auction house to collect fee for listing items with a chance-based incentive at the time the items are listed. In another variation, different incentive values and odds of winning may be applied to each group, based on the price range of sale items in the group.

In another variation, a chance-based incentive may be combined with other features designed to provide listings with more visibility. For example, listings having associated chance-based listings may be provided with “featured” placement in lists of listings displayed in response to a search. In other variations, listings having associated chance-based incentives may be listed on separate pages or screens. Selected listings having chance-based incentives may be listed on the auction house home page or on introductory screens. Screen displays including the auction house home page may include sections promoting the chance-based incentive program and include links to pages explaining the program in detail.

In other variations, the auction house may give sellers that use chance-based incentives a predetermined number of times a free listing or free listing features such as “featured” presentation of their listings. For example, a seller who lists twenty items using a chance-based incentive may have their next listing displayed on the auction house home page as a special or “featured” listing. Alternatively, sellers that list a predetermined number of listings and buyers that purchase a predetermined number of items listed with chance-based incentives using chance-based incentives may be entered into a lottery or sweepstakes for a prize.

In one embodiment, the entity that administers and conducts the chance-based incentive program is a business entity separate and distinct from the auction house. In this variation, the separate business entity may collect fees from sellers who elect to purchase a chance-based incentive and remit a portion of the fees to the auction house. The separate business entity may conduct the random selection process, notify purchasers and/or successful bidders of the outcome of the selection process and remit the value of the incentive to winning purchasers and/or bidders.

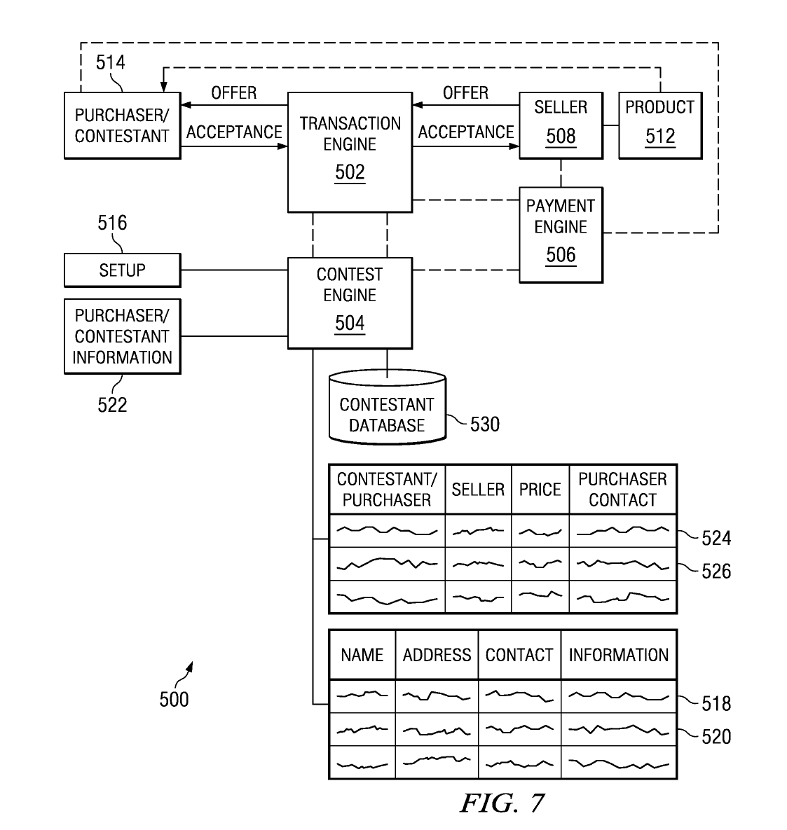

Referring now to FIGS. 7 and 8, in one variation, a system 500 for applying a chance-based incentive to an online transaction includes an electronic transaction engine 502 for facilitating the sale of products 512, (e.g. goods and services), using a private or public network 510. As illustrated, transaction engine 502 facilitates the sale of products 512 by, among other things, transmitting offers from sellers 508 to sell products and acceptances of offers from the purchasers 514 to the sellers. System 500 further includes an electronic contest engine 504 for conducting a contest in connection with transactions conducted via transaction 502. System 500 may further includes an electronic payment engine 506 for facilitating payment for goods and services sold utilizing transaction engine 502 and associated fees. Users, e.g., sellers 508 and purchasers 514, utilize communication devices 106 (FIG. 1) such as personal computers, cell phones and similar devices to communicate with transaction engine 500, contest engine 502 and/or payment engine 506 via a private or public network 510 such as the Internet.

In one embodiment, transaction engine 500 operates an online auction site and conducts online auctions wherein sellers may list items for sale and bidders may bid on such items. In other embodiments, sellers 508 may simply offer goods or services for sale at a fixed price. In either case, contest engine 504 provides sellers 508 with the option of using a chance-based incentive as a sales aid in connection with selected products. In one variation, electronic transaction engine 502, electronic contest engine 504 and electronic payment engine 506 are owned and operated by different entities. In another, two or more of transaction engine 502, contest engine 504 and/or payment engine 506 may be owned and operated by the same entity. Transaction engine 502, contest engine 504 and payment engine 506 may be in diverse geographic locations and may utilize a private or public network such as the internet 510 to facilitate and conduct transactions with sellers 508 and buyers or purchasers 514.

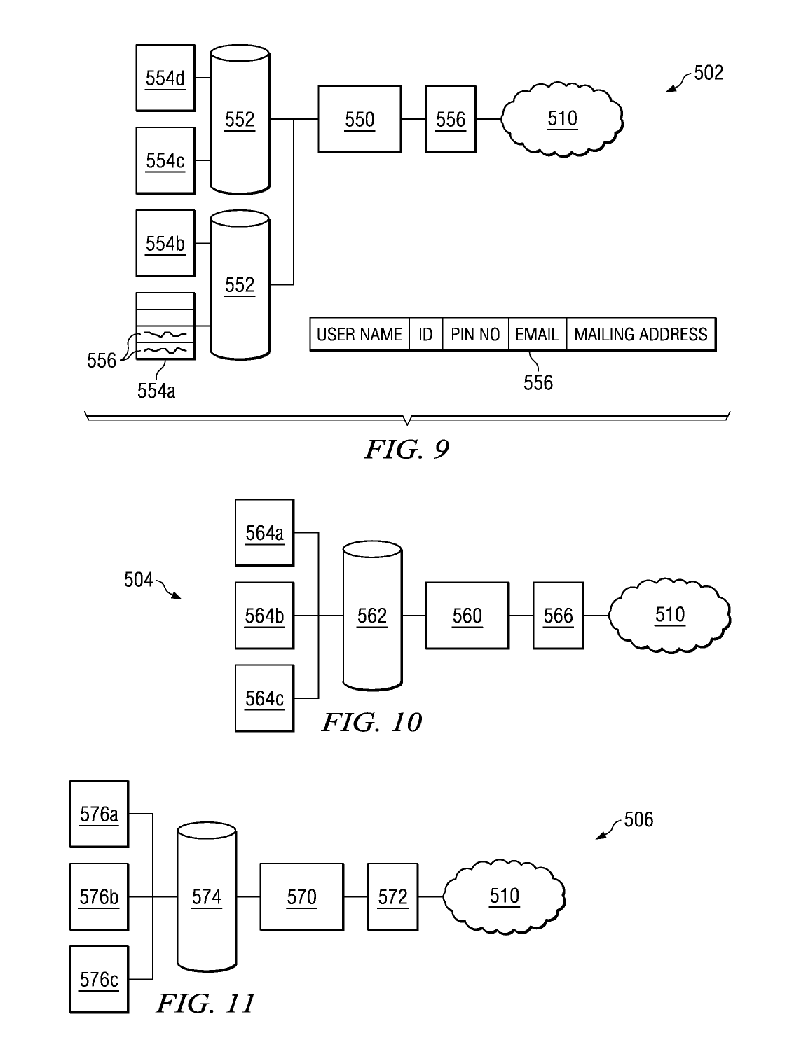

Turning to FIG. 9, in one variation, transaction engine 502 comprises one or more computers and/or file servers 550 operably connected to data storage devices 552. Data storage devices 552 may include databases 554 for storing information required to operate transaction engine 502. For example, in the case where engine 502 comprises an online auction house, database 554a may include records 556 for information regarding registered users such as name, user ID, user PIN No. email address, mailing address and other information. Database 554b may include financial information including financial records for the engine, database 554c may include records for items listed for sale and database 554d may include historical and statistical information regarding user history and data for items sold on the online action site. Engine 502 includes a bi-directional data communications interface 556 for communicating with other computers and/or servers over a public or private network.

Where transaction engine 502 comprises an online auction, computer 550 includes software for communicating with users, including programs for generating screens and interactive displays similar to those of FIGS. 2, 3 and 6 to convey and receive information from prospective sellers regarding products that the sellers wishes to auction. In the case of an online auction site, computer 550 may include programs that search databases 554 for specific items in response to search criteria received from prospective bidders, identify such items and create displays listing and describing such items. Computer 550 may also include programs to enable the engine to communicate with financial institutions to receive and transfer funds, facilitate payment by means of payment engine 506 and provide for the use of chance-based incentives by sellers wishing to enhance their product listings. Transaction engine 502 may further include programs to enable users to generate reports, review prior transactions, place proxy bids on products for sale and perform other functions.

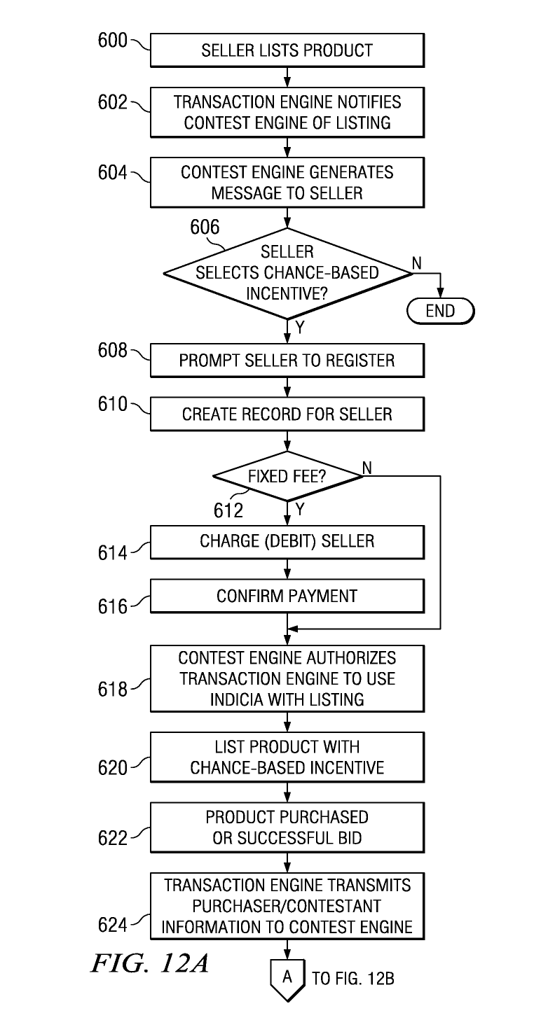

Turning to FIG. 10, in one embodiment, contest engine 504 includes one or more computers 560 operably connected to one or more data storage devices 562. Data storage devices 562 may include a plurality of databases 564 for storing data regarding registered users (564a), successful bidders and/or purchasers (564b) and historical and statistical information (564c). In one variation, computer 560 includes software and programs for creating interactive displays and screens enabling the computer to communicate with contestants and sellers and transaction engine 502. Computer 560 may further include programs and software for using one or more random selection processes to select winners of contests conducted using contest engine 504. Contest engine 504 further includes a bi-directional data communications interface 566 to enable computer 560 to communicate with users such as purchaser/contestants 514, sellers 508, transaction engine 502, payment engine 506 and other computers via network 510.

Turning to FIG. 11, in one variation, a payment engine 506 includes one or more computers and/or servers 570 with a bi-directional data communications interface 572 enabling the payment engine 506 to communicate with users and financial institutions via a private or public network 510. In one embodiment, payment engine 506 includes one or more data storages devices 574 with data bases 576. Databases 574 may include information regarding users (576a), information regarding other financial institutions (576b) and historical and statistical information (576c). Payment engine 506 includes software and programs resident on computer 570 for accessing information in databases 574 and for communicating with users and other financial entities such as banks, credit card companies and similar entities to conduct and/or facilitate financial transaction via network 510.

In one variation, payment engine 506 includes software enabling users to receive and transfer funds to one or more of transaction engine 502, contest engine 504, sellers 508 and purchasers 514 (FIG. 7). For example, a seller 508 may use payment engine 506 to pay listing fees and/or commissions for items listed using transaction engine 502. Purchasers 514 may use payment engine 506 to pay for items purchased via transaction engine 502. In one variation, payment engine 506 accesses a user's account maintained with another financial entity such as a bank or credit card company to debit or credit or the user's account for fees, purchases and payments. For example, payment engine 506 may enable a purchaser 514 to remit the purchase price of a product 512 to a seller 508 by debiting a purchaser's account and transferring the funds to the seller's account.

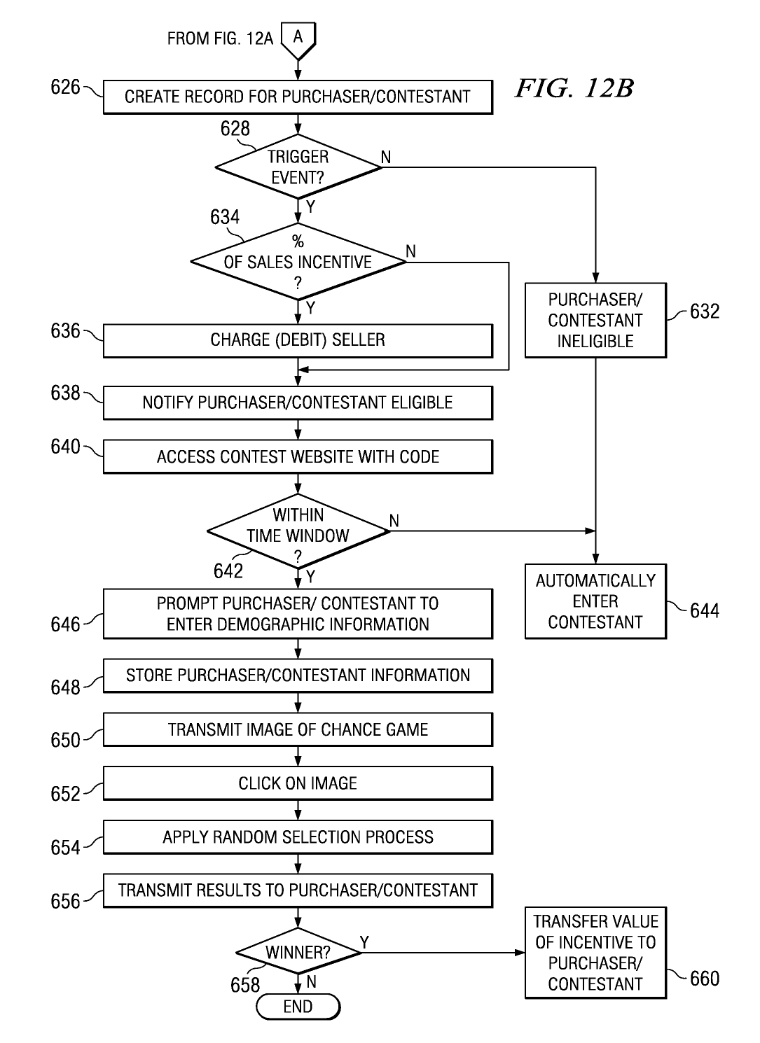

Referring now to FIG. 7 and 12 in conjunction, in one embodiment a seller 508 lists or offers a product 512 for sale (Step 600) using transaction engine 502 which transmits information regarding the product to purchasers 514 in response to queries initiated by purchasers. The seller may be charged a listing fee, which the seller may pay using payment engine 506 which debits an account that the seller has authorized the payment engine to debit. In one variation, at the time seller 508 lists the product using transaction server 502, the transaction server transmits contact information such as the seller's email address or telephone number to contest engine 504 (Step 602). Contest engine 504 then generates a message to seller 508, offering the seller the opportunity to apply a chance based incentive to items offered for sale by the seller via transaction engine 502 (Step 604). In another variation, transaction engine 502 provides a link or address to a website maintained by contest engine 504 where the seller may purchase a chance-based incentive for a product to be listed with transaction engine 502.

The message from contest engine 504 to seller 508 may be transmitted by email and include a link to a site maintained by contest engine 504 wherein sellers may register and select a chance based-incentive to be offered with his or her product. In one embodiment, in order to preserve the privacy of sellers 508, transaction engine 502 does not transmit the seller's contact information. Rather, transaction engine 502 notifies contest engine 504 of the listing and the message from the contest engine 504 to the seller is routed back through the transaction engine to sellers 508 such that the seller's contact information is not disclosed.

The message from contest engine 504 to seller 508 presents the seller the opportunity to attach a chance-based incentive to his or her offer to sell product 512. Such chance based incentives may be a “seller pays,” a “buyer wins,” a “sweepstakes” or a “buyer surprise” as described above. If seller 508 chooses a chance-based option (Step 606), contest engine 504 queries the seller to register, i.e. provide information such as the seller's name, address and contact information in order to register the seller (Step 608). The contest engine may also require the seller to provide necessary information and authorization to permit the contest engine to conduct financial transactions with the seller through payment engine 506.

Using the seller information, contest engine 504 initiates a set up routine 516, creating a record 518 for seller 508 in a database 520 (Step 610). Alternatively, contest engine 504 may transmit a message to seller 508 requesting the seller to authorize transaction engine 502 to transmit the seller information to contest engine 504. Upon receiving such authorization, contest engine 504 may transmit the authorization to transaction engine 502 which, in turn, transmits the seller information to the contest engine to create a record 518 for the seller.

In one variation, seller 508 may agree to pay a percentage of the sale price of the item as a fee for the incentive, in another, the seller pays a fixed fee. If seller 508 elects to use a chance-based incentive having a fixed fee (Step 612), the seller may pay for the incentive using payment engine 506 at the time the seller chooses the incentive (Step 614). Seller 508 may also be charge a registration fee or in the case of a seller that selects chance-based incentive based on a percentage of the sale price, the seller may be required to provide a deposit to insure that funds are available to pay for the chance-based incentive at the time of sale. Payment engine 506 may be used to collect the registration fee and deposit, if any.

Payment engine 506 may provide a service that debits a sellers's account such as a checking account, a debit or credit card account or a similar account to pay for the fixed fee chance-based option. In the case of a fixed fee chance based incentive, upon receiving the message from contest engine 504 payment engine 506 debits the seller's account, transmits the fees to an account associated with contest engine 504 and transmits a message to the contest engine that the fee for the incentive has been paid. If seller 508 has selected a chance-based incentive, contest engine 504 may contact payment 506 in insure that the seller is registered with the payment engine.

After payment of the fixed fee, or confirmation of an account with payment engine 506 (Step 616), contest engine 504 then transmits a message to transaction engine 502 authorizing the use of indicia with the listing or display of the seller's product 512 indicating that the product is offered for sale with the chance-based incentive (Step 618). If seller 508 chooses a chance based incentive based on a percentage of the sale price of the item, the seller may be charged at the time of the sale or another trigger event. Transaction engine 502 then lists product 512 with an indicia such as indicia 250 (FIG. 6) indicating to potential purchasers or bidders 514 that a purchaser of product 512 will be eligible to win the chance-based incentive selected by seller 508 (Step 620).

Referring still to FIGS. 7 and 12, when product 512 is sold or at the termination of the auction with a successful bid (Step 622), transaction engine 502 transmits a message to contest engine 504, providing the contest engine with the name of purchaser 508, the sale price and purchaser contact information such as an email address (Step 624). Contest engine uses the purchaser/contestant information 522 to create a record 524 in contest database 526 (Step 626) for the purchaser/contestant 514. After the after the occurrence of a trigger event (Step 628) contest engine 504 determines whether the seller selected a chance based incentive having a fee equal to a percentage of the sale price of the product (Step 634) and if so, charges the seller the fee (Step 636). If the trigger event does not occur, purchaser 514 is determined to be ineligible to enter the contest (Step 632).

In one embodiment, after the trigger has occurred (Step 628), contest engine 504 notifies the purchaser/contestant that he or she is eligible to win the chance-based incentive selected by seller 508 (Step 638). In one variation, notification of the sale serves as a trigger event that causes contest engine 504 to notify purchaser or successful bidder 514 that he or she is eligible to participate in the chance based incentive program. In another variation, the trigger event is notification that seller 514 has been paid either from seller 508 or from payment engine 506 if the purchaser uses the payment engine to pay for product 512. In yet another variation, contest engine 504 delays notification of the purchaser for a fixed period to enable seller 508 to receive payment for product 512. For example, if seller 508 does not receive payment within the predetermined period the seller may transmit a message to contest engine 504 to disqualify the purchaser from participating the chance-based incentive program (Step 632).

In one variation, in order to preserve the privacy of purchaser/contestants 514, transaction engine 502 does not transmit the purchaser's contact information to contest engine 504 when notifying contest engine 504 of the purchaser or successful bid (Step 624). Rather, transaction engine 502 notifies contest engine 504 of the successful bid or purchase and the message (Step 634) from the contest engine 504 to the purchaser is routed back through the transaction engine to purchaser 514 such that the purchaser's contact information is protected.

Upon receiving notification that the trigger event has occurred (Step 628), contest engine 504 transmits a message to the purchaser or successful bidder 514 that he or she is authorized to participate in the chance-based incentive program (Step 638). The message from contest engine 504 to the purchaser/contestant 514 will, in one variation, contain an authorization code. In this variation, to participate in the chance-based incentive program, purchaser/contestant 514 may access a contest website connected to contest engine 504 and enter the authorization code (Step 640).

In one variation, purchaser/contestant 514 must access the website within a predetermined period or window, for example within 14 to 60 days from the date of notification to participate in the contest for the chance-based incentive (Step 642). If the purchaser does not access the website within the predetermined time period, the purchaser may be determined ineligible (Step 632) and loose the opportunity to participate. In another variation, contest engine 504 may automatically enter purchaser/contestant in the program at the end of the time window (Step 644).

In one embodiment, at the time purchaser/contestant accesses the contest website, the contest engine prompts purchaser/contestant 514 to enter demographic and other information such as the purchaser/contestant's full name, address, age, contact information such as an email address and phone number, martial status and other information (Step 646). Contest engine 504 may store (Step 648) such information in a contestant database 530 (FIG. 7) for future use, such as statistical analysis, future promotions, mailing lists and other purposes.

In one variation, upon receiving the authorization code entered by purchaser/contestant 514, contest engine 504 utilizes a random selection process to determine if purchaser 514 is a winner of the incentive. To entertain purchaser/contestant 514, the contest engine may transmit a representation of a roulette wheel, a slot machine or other game of chance for display to the purchaser (Step 650). Purchaser 514 may then click on the display to activate the random selection process (Step 652) while an image of a spinning roulette wheel, a spinning slot machine or a similar representation is displayed for a predetermined period of time. Contest engine 504 then applies or invokes a random selection process to determine if purchaser/contestant 514 is a winner of the chance-based incentive (Step 654).

After the random selection process has been applied to determine whether purchaser 514 has won the chance-based incentive (Step 654), contest engine 504 transmits a message to purchaser/contestant 514 informing the purchaser of the results of the random selection process (Step 656). If purchaser/contestant 514 has won the chance based incentive (Step 658), contest engine then transmits or arranges for the transfer of the chance-based incentive value to purchaser/contestant 514 (Step 660). In one variation, if purchaser 504 is selected as a winner, contest engine 504 transmits a message to payment engine 506 authorizing the payment engine to debit an account maintained in connection with the payment engine and transfer the value of the incentive to the purchaser/contestant's account. In other variations, contest engine 504 notifies the operator of the contest engine to draft and mail a check to the winner.

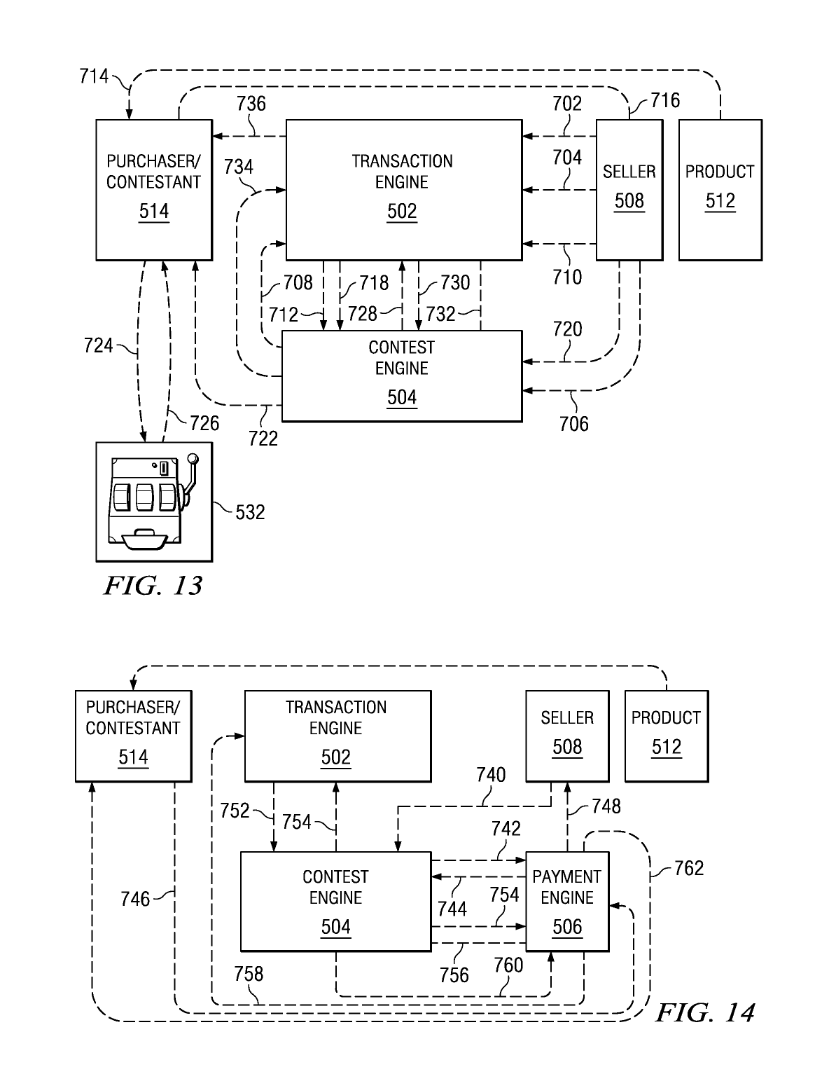

FIG. 13 illustrates the flow of information and funds in a transaction conducted using transaction engine 502 and contest engine 504. In this variation, funds for listing product 512 with a chance-based incentive are routed through transaction engine 502. As indicated by arrows 702, 704, seller 508 lists a product with transaction engine 502 which then collects the listing fee from the seller. Seller 508 may register with contest engine 504 (arrow 706) in response to a message generated by either the contest engine or transaction engine 502 at the time the seller lists product 512 offering a chance-based incentive.

After the seller registers and selects the chance-based incentive, contest engine 504 authorizes transaction engine 502 to list or display product 512 to potential purchasers 514 as indicated by arrow 708. In the case of a fixed fee chance-based incentive, transaction engine 502 then collects the incentive fee from seller 508 for the price of the incentive (arrow 710) and transmits the incentive fee, less a percentage for the contest engine to the transaction engine (arrow 712). References to transfers of fees and funds to and from transaction engine 502, contest engine 504 and payment engine 506 means that the funds are transferred to accounts maintained in connection with the engines and which may be debited and credited by, through or with the engines to pay fees, for items purchased via the transaction engine and to transfer the value of chance-based incentives to winning bidders or purchasers.

When product 512 is sold, or a successful bid is received for the product, transaction engine 502 notifies seller 508 and, in the case of an auction, purchaser 514. Purchaser 514 transmits payment for product 512 to seller 508 who transfers the product to the purchaser (arrows 714, 716). Transaction engine 502 also notifies contest engine 504 of the sale and/or successful bid and transmits the purchaser information and any other information necessary to for the contest engine to (arrow 718) to apply a random selection process to determine whether purchaser/contestant 514 is a winner of the change-based incentive.

In one variation, contest engine 504 receives confirmation from seller 512 that the seller has received payment for product 512 before notifying purchaser 514 that he or she is eligible to win the chance-based incentive. In another variation, the seller is given a predetermined period in which to notify contest engine 504 that purchaser 514 has not paid, in which case, the purchaser becomes ineligible to win the incentive. After notice of payment by seller 508, or expiration of the predetermined period, contest engine 504 notifies purchaser 514 (arrow 722) that he or she is eligible to win the chance-based incentive and transmits an authorization number to the purchaser, enabling the purchaser to access a website 532 (arrow 724). Contest engine 504 then applies a random selection process to determine if purchaser 514 is a winner and transmits the results to the purchaser (arrow 726) and contest engine 502 (arrow 728).

If seller 508 selected a chance-based incentive having a fee equal to a percentage of the sale price, transaction engine 502 calculates the fee and transmits the incentive fee, less a percentage for the transaction engine, of the chance based incentive to contest engine 504 (arrow 732). In the event that purchaser 514 is a winner of the chance-based incentive, contest engine 504 transmits the value of the incentive to transaction engine 502 (arrow 734) which transfers the value to purchaser 514 (arrow 736).

As will be appreciated, in one variation the contest engine may be completely transparent to purchaser 514. In this variation, all communications between contest engine 504, seller 508 and purchaser 514 are routed though transaction engine 502 using messages and screen displays that identify only the transaction engine. Website 532 may be configured to identify only transaction engine 502 with no reference to contest engine 504. This variation permits a third party to operate contest engine 504 in a manner that is transparent to sellers 508 and purchasers 514.

Turning to FIG. 14, in another variation, fees for listing product 512 with a chance-based incentive are routed through payment engine 506. When seller 508 registers with contest engine 504 and selects a fixed fee chance-based incentive (arrow 740), the contest engine 504 notifies payment engine 506 (arrow 742) which debits the seller's account and transfers the fee to the contest engine (arrow 744). In this variation, purchaser 514 may also pay seller 508 for the purchase of product 512 using payment engine 506 as indicated by arrows 746, 748.

If seller 508 selected a chance-based incentive having a fee equal to a percentage of the sale price, when product 512 is purchased and/or a successful bid is received for the product, transaction engine 502 transmits the sales price and purchaser information to contest engine 504 (arrow 752). Contest engine 504 calculates the incentive fee and notifies payment engine (arrow 754) which debits the seller's account and transmits the fee, less a percentage for the transaction engine, to contest engine 506 (arrow 756). In this variation, payment engine 506 may transmit the transaction engine's percentage of the incentive fee directly to transaction engine 502 (arrow 758). If contest engine 504 determines that purchaser 514 is a winner of the chance based incentive as described above, the contest engine notifies payment engine 506 (arrow 760) which debits the payment from an account maintained in connection with the contest engine and transmits the value of the incentive to purchaser 514.

In one variation, in those jurisdictions that require an alternate method of entry, contest engine 504 and/or transaction engine 502 provide users with an AMOE. In this variation, transaction engine 502 may display a link to an alternative entry site maintained by contest engine 504 with the display or listings of product(s) transmitted to potential purchasers 514. Users that desire to participate in the chance-based incentive or an equivalent contest without purchasing a product listed using transaction engine 502, may click on the link displayed with the listing. The link may be the same or similar to the “enter free” icon 252 of FIG. 6. In one embodiment the user is connected to a web page where he or she may obtain an address and/or a form for requesting an authorization code to enter the chance-based incentive promotion or a similar equivalent contest. The user may then enter the contest without purchasing products listed for sale using transaction engine 502.

The drawings and detailed description herein are to be regarded in an illustrative rather than a restrictive manner, and are not intended to limit the following claims to the particular forms and examples disclosed. On the contrary, further modifications, changes, rearrangements, substitutions, alternatives, design choices, and embodiments will be apparent to those of ordinary skill in the art. Thus, it is intended that the following claims be interpreted to embrace all such further modifications, changes, rearrangements, substitutions, alternatives, design choices, and embodiments.

1. A system for enhancing an online transaction using a transaction engine having a data communications interface allowing a seller to communicate information relating to a product for sale to the transaction engine via a network, the transaction engine transmitting information regarding the product to potential purchasers via the network, the system comprising:
a contest engine including a communications interface enabling the contest engine to communicate with the transaction engine and with the seller of a product, the contest engine communicating with the seller and with the transaction engine to associate a chance-based incentive with a product offered for sale by the seller using the transaction engine, the chance-based incentive being associated with the product by means of indicia presented in a display of information regarding the product transmitted by the transaction engine to potential purchasers via the network.

2. The system of claim 1 wherein the transaction engine operates an online auction site through the data communications interface wherein sellers transmit information regarding products for sale and the transaction engine transmits a listing of products for display on a user communication device in response to a query, the listing including indicia indicating that one or more products offered by sale include a chance-based incentive.

3. The system of claim 1 wherein the contest engine receives information from the transaction engine through the data communications interface identifying a listing of a product for sale by a seller and transmits a message to the seller through the data communications interface, the message offering to provide a chance-based incentive with the seller's listing.

4. The system of claim 3 wherein the transaction engine removes the seller's contact information from the information identifying the seller's listing and wherein the message from the contest engine is transmitted to the transaction engine via the communications interface and then to the seller.

5. The system of claim 3 wherein the contest engine transmits an authorization to the transaction engine through the data communications interface authorizing the transaction engine to display indicia with the seller's listing, the indicia indicating that the product is offered for sale with the chance-based incentive.

6. The system of claim 2 wherein the transaction engine receives search criteria from a potential purchaser via the data communications interface, identifies products listed for sale by sellers and transmits a listing of products meeting the search criteria to the potential purchasers for display on a personal communication device, the listing including indicia identifying products offered for sale with a chance-based incentive.

7. The system of claim 1 wherein the contest engine further comprises a computer operating a random selection program wherein the random selection process determines whether a purchaser wins the chance-based incentive.

8. The system of claim 1 wherein the seller pays a fixed price for listing the product with the chance-based incentive.

9. The system of claim 1 wherein the seller pays a percentage of the purchase price of the product as a fee for the chance based incentive.

10. The system of claim 1 wherein the contest engine maintains a webpage accessible by purchasers of products listed using the transaction engine with a chance-based incentive, whereby a purchaser may enter an authorization code to activate a random selection process to determine if the purchaser is a winner of a chance-based incentive.

11. A system for enhancing an online auction comprising:
a transaction engine having a data communications interface for operating an online auction via a public or private network and for communicating with sellers and potential purchasers, the transaction engine receiving information from sellers relating to products offered for sale via the network, the transaction engine transmitting a listing of products to potential purchasers for display on personal communications devices and receiving bids for the products from potential purchasers; and
a contest engine including a communications interface enabling the contest engine to communicate with the transaction engine and with sellers of the products, the contest engine communicating with the seller and with the transaction engine to associate a chance-based incentive with a product offered for sale by a seller using the transaction engine, the chance-based incentive being associated with the product by means of indicia displayed in a listing of products transmitted by the transaction engine to potential purchasers via the network.

12. The system of claim 11 wherein the seller pays one of a fixed fee or a percentage of the sale price of a product for listing the product for sale with a chance-based incentive.

13. The system of claim 11 the contest engine, transaction engine, sellers and purchasers communicate with a payment engine including a data communications interface with the network, the payment engine transferring funds from accounts maintained by sellers for payment of fees for chance-based incentives when authorized by the sellers.

14. The system of claim 13 wherein the payment engine transmits fees for chance-based incentives from accounts maintained by sellers to an account maintained in connection with the contest engine for receiving such fees when authorized by the seller.

15. The system of claim 13 wherein the payment engine transmits fees for chance-based incentives from accounts maintained by sellers to an account maintained in connection with the transaction engine for receiving such fees when authorized by the sellers.

16. The system of claim 11 wherein the contest engine further comprises a computer operating a random selection program wherein the random selection process determines whether a purchaser wins the chance-based incentive and wherein the contest engine communicates with a payment engine via the network and authorizes the payment engine to transfer the value of the chance-based incentive to a winning purchaser.

17. The system of claim 11 wherein the transaction engine uses the data communications interface to communicate with the contest engine over the network to identify listings for products.

18. The system of claim 17 wherein the contest engine uses the data communications interface to communicate with the sellers of the products over the network to offer the sellers a chance-based incentive to be provided to purchasers of the products.

19. The system of claim 18 wherein the contest engine uses the data communications interface to communicate with the transaction engine to authorize the transaction engine to display an indicia indicating products offered for sale with a chance-based incentive.

20. The system of claim 19 wherein communications between the contest engine and the seller are routed though the transaction engine.

21. A computer-implemented method of conducting an online auction, comprising:
receiving listing information from a seller for creating a listing for a product offered for sale by the seller;
enabling the seller to select a chance-based incentive to encourage bidders to bid on the product;
storing the listing information in a computer searchable database and identifying those listings having associated chance-based incentives;
receiving one or more search requests including search criteria from one or more potential bidders;
searching a database for products matching the search criteria;
transmitting information for those products matching the search criteria such that a list of those products matching the criteria can be displayed to one or more potential bidders and identifying those products having a chance-based incentive;
receiving one or more bids for the item from one or more bidders and identifying a successful bid for the product and the successful bidder placing the successful bid; and
determining whether the successful bidder is the winner of the chance-based incentive.

22. The method of claim 21 wherein the seller pays a fee for listing the sale product with the chance-based incentive.

23. The method of claim 21 wherein a plurality of sellers each pay a fee for listing sale products with a chance based incentive.

24. The method of claim 22 wherein the fee is a percentage of the final sale price of the sale product.

25. The method of claim 24 further comprising calculating the fee after completion of the auction.

26. The method of claim 25 further comprising collecting the fee after completion of the auction.

27. A computer implemented method of conducting an online auction comprising:
receiving criteria enabling a search of a database of information regarding products for sale;
searching the database using one or more criteria and identifying products matching the criteria and further identifying products matching the criteria having an associated chance-based incentive;
transmitting an electronic message enabling a display of information for those products matching the criteria including for those products having an associated chance-based incentive an indicia indicating that a chance-based incentive is associated with the product;
receiving bids for one of the products having an associated chance-based incentive and identifying a successful bidder; and
applying a random selection process to determine whether the successful bidder is a winner of the chance-based incentive.

28. The method of claim 27 further comprising transferring the chance-based incentive to the successful bidder.

29. The method of claim 27 further comprising receiving listing information from a plurality of sellers and creating a plurality of listings for products offered for sale by the sellers; and
enabling the sellers to select a chance-based incentive to encourage bidders to bid on the products.

30. The method of claim 29 further comprising collecting a fee from those sellers that select a chance based incentive.

31. The method of claim 30 wherein the collected fees are a percentage of the final sales price of products sold by those sellers that select a chance based incentive.

32. A computer-implemented method of enhancing an online auction comprising:
providing a seller of a product to be sold via the online auction with a chance-based incentive to be awarded to a purchaser of the product;
authorizing the product to be listed for sale in the online auction with indicia indicating that the product is offered with a chance based incentive;
applying a random selection process to determine if a purchaser of the product is a winner of the chance-based incentive; and
receiving a fee from the seller for providing the chance-based incentive.

33. The method of claim 32 wherein the step of providing a seller of a product to be sold via the online auction with a chance-based incentive to be awarded to a purchaser of the product further comprises:
identifying sellers of products listed for sale with the online auctions;
transmitting a offer to such sellers to provide the chance-based incentive; and
receiving acceptances of the offer from sellers.

34. The method of claim 33 further comprising the step of providing a webpage where sellers may choose a chance-based incentive.

35. The method of claim 32 further comprising the step of confirming that a purchaser of a product listed for sale in the online auction with a chance-based incentive has paid the seller for the product prior to applying the random selection process.

35. The method of claim 32 further comprising the step of providing a predetermined period of time in which the seller may provide notification that a purchaser has not paid for a product listed for sale in the online auction with a chance-based incentive prior to applying the random selection process.

36. The method of claim 32 wherein the seller pays one of a fixed price or a percentage of the sale price of the product as a fee for the chance-based incentive.

37. The method of claim 36 further comprising the step of calculating the fee at the end of the auction.

38. The method of claim 32 further comprising receiving fees from sellers for providing chance-based incentives from an electronic payment engine.

39. The method of claim 32 further comprising the step of transferring the value of the chance-based incentive to a winning purchaser.

40. The method of claim 32 further comprising the step of authorizing an electronic payment engine to transferring the value of the chance-based incentive to a winning purchaser.
